(19) United States
(12) Patent Application Publication
(10) Pub. No.: US 2020/0202230 A1
(43) Pub. Date: Jun. 25, 2020

(54) COGNITIVE DEVICE SUPPORT FOR POTENTIALLY AFFECTED DEVICES

(71) Applicant: International Business Machines Corporation, Armonk, NY (US)

(72) Inventors: RAJENDRAN SUBRAMANIAM, TUCSON, AZ (US); CRAIG J. MARTENSEN, HIGHLAND, NY (US); JOHN T. MOWATT, CEDAR PARK, TX (US); SU LIU, AUSTIN, TX (US); PERRY DYKES, BYRON, MN (US); PRIYA PAUL, AUSTIN, TX (US); JOHN J. GOODSON, AUSTIN, TX (US)

(21) Appl. No.: 16/225,134

(22) Filed: Dec. 19, 2018

(51) Int. Cl. G06N 5/02; G06Q 10/00; G06Q 30/00

(52) U.S. Cl. CPC G06N 5/022; G06Q 30/016; G06Q 10/20

(57) ABSTRACT

Cognitive device support for potentially affected devices may include: receiving a plurality of support issues; identifying, from the plurality of support issues, a plurality of correlated support issues having one or more correlated attributes; identifying, based on the one or more correlated attributes, one or more potentially affected devices associated with the plurality of correlated support issues; identifying a resolution associated with the plurality of correlated support issues; and providing the resolution to one or more entities associated with the one or more potentially affected devices.

### BACKGROUND

### Field of the Invention

The field of the invention is data processing, or, more specifically, methods, apparatus, and products for cognitive device support for potentially affected devices.

### Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Support may be offered when a device experiences an issue in performance (e.g., a software crash, unexpected performance, hardware failures, etc.). Typically, support is initiated by a user after such an issue has occurred. Thus, support is typically reactive to already experienced issues.

### SUMMARY

Cognitive device support for potentially affected devices may include: receiving a plurality of support issues; identifying, from the plurality of support issues, a plurality of correlated support issues having one or more correlated attributes; identifying, based on the one or more correlated attributes, one or more potentially affected devices associated with the plurality of correlated support issues; identifying a resolution associated with the plurality of correlated support issues; and providing the resolution to one or more entities associated with the one or more potentially affected devices.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 is a diagram of an example system for cognitive device support for potentially affected devices.

FIG. 2 is a block diagram of a computer for cognitive device support for potentially affected devices.

FIG. 3 is a flowchart of an example method for cognitive device support for potentially affected devices.

FIG. 4 is a flowchart of an example method for cognitive device support for potentially affected devices.

FIG. 5 is a flowchart of an example method for cognitive device support for potentially affected devices.

FIG. 6 is a flowchart of an example method for cognitive device support for potentially affected devices.

FIG. 7 is a flowchart of an example method for cognitive device support for potentially affected devices.

FIG. 8 is a flowchart of an example method for cognitive device support for potentially affected devices.

### DETAILED DESCRIPTION

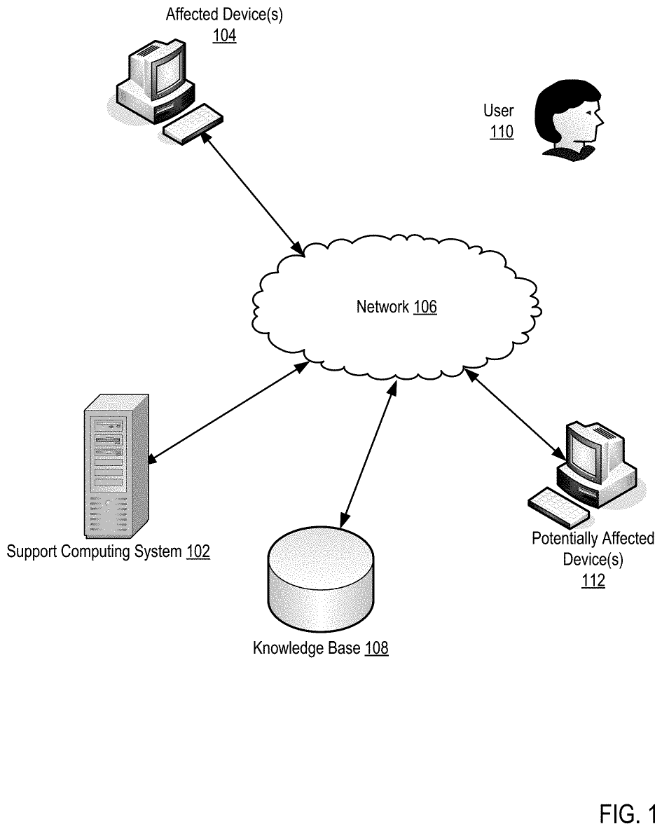

Exemplary methods, apparatus, and products for cognitive device support for potentially affected devices in accordance with the present invention are described with reference to the accompanying drawings, beginning with FIG. 1. FIG. 1 sets forth a network diagram of a system configured for cognitive device support for potentially affected devices according to embodiments of the present invention. The system of FIG. 1 includes a support computing system 102 that is configured to receive, via a network 106, a plurality of support issues associated with affected devices 104. The affected devices 104 may comprise a computer, server, mobile device, smart phone, tablet, hand held device, or other computing device as can be appreciated. The network 106 may comprise one or more Local Area Networks (LANs), Wide Area Networks (WAN), Personal Area Networks, mesh networks, cellular networks, internets, intranets, other networks as can be appreciated, or combinations thereof.

The support issues comprise indications or descriptions of performance issues experienced by a respective affected device 104. For example, such performance issues can comprise software crashes or failures, unexpected or erroneous functionality, hardware failures or outages, or other performance issues as can be appreciated. The support issues may also comprise an identifier of an affected device 104 (e.g., a user identifier, an account identifier, a customer identifier, a device identifier, etc.).

The support issues may also comprise one or more attributes associated with the respective affected device 104. Such attributes can include a description of one or more hardware components of the affected device 104, an indication of an operating system and/or operating system version, an indication of one or more executed applications, or other attributes of the affected device 104.

Receiving the plurality of support issues may comprise receiving an indication of a performance issue from the respective affected device 104. For example, receiving an indication of a performance issue can comprise receiving an error log, stack trace, or other indication of a performance issue. Such an indication of a performance issue may be automatically generated by one or more affected applications, an operating system, or another functional component of the affected device 104. Receiving the plurality of support issues may also comprise receiving an indication of a performance issue as a user input or submission. For example, receiving an indication of a performance issue as a user input or submission may comprise receiving a bug report, support ticket, support email, or other user-generated submission indicating a performance issue.

Receiving the plurality of support issues may also comprise receiving a support issue generated by an analytics engine monitoring social media, chat logs, email messages, text messages, text transcriptions of voice calls or voicemails, or other natural language sources. The analytics engine may analyze natural language data to identify, for example, one or more keywords or descriptors associated with a performance issue. The analytics engine may also determine the affected device based on the natural language data, a user account associated with the natural language data, an identifier included in the natural language data, etc. The analytics engine may then generate the support issue as comprising the keywords, descriptors, an indication of the affected device, etc.

The attributes of the support issue may be received from a source of the support issue (e.g., from the affected device 104, from a user input). One or more attributes of the support issue may also be generated by the support computing system 102 based on another attribute. For example, the support computing system 102 may query a relational database, lookup table, or other data source using a device identifier, user identifier, account identifier, or other identifier to receive one or more other attributes of the affected device 104 (e.g., one or more hardware components of the affected device 104, an operating system of the affected device 104, etc.)

In response to receiving the support issues, the support computing system 102 may store the support issues in a knowledge base 108. The knowledge base 108 encodes known support issues and, if known, resolutions for the support issues. Accordingly, the knowledge base 108 may comprise a relational database, lookup table, machine learning model (e.g., a supervised machine learning model or unsupervised machine learning model), or other data structure.

After receiving the plurality of support issues, the support computing system 102 may identify one or more correlated support issues. The one or more correlated support issues are support issues having identical or similar performance issues (e.g., a same error code, having similar keywords or descriptors, having a same predefined category or tag, etc.) and having one or more identical or similar attributes, hereinafter referred to as correlated attributes (e.g., one or more identical or similar hardware components of an affected device 104, a same operating system, a same or similar operating system or software version, etc.). The correlated attributes may be factors in whether a device may experience a particular support issue. Identifying the one or more correlated support issues may comprise encoded an indication that the one or more support issues are correlated in the knowledge base 108 (e.g., a flag, a reference, a table entry or data structure relating one or more of the support issues).

Identifying one or more correlated support issues may comprise applying a clustering algorithm (e.g., k-means clustering) to the attributes of the support issues in order to generate one or more clusters of support issues. The support issues within a particular cluster may be identified as correlated support issues. Identifying one or more correlated support issues may comprise determining a degree of similarity (e.g., cosine similarity) between the attributes of the support issues. The correlated support issues may then be identified as those support issues having a degree of similarity satisfying a threshold.

The support computing system 102 may determine if a number of correlated support issues (e.g., a number of support issues within a particular grouping of correlated support issues) satisfies a threshold. For example, the support computing system 102 may determine if a number of correlated support issues within a time window satisfies the threshold. The time window may be based on a time at which a support issue is received. The time window may also be a sliding time window. For example, assuming a threshold of five correlated support issues and a sliding time window of two hours, the support computing system 102 may determine if at least five of the correlated support issues occurred within a consecutive two-hour period. The time window may also be based on a current time. For example, assuming a threshold of five correlated support issues and a time window of two hours, the support computing system 102 may determine if at least five of the correlated support issues occurred within the last two hours.

The support computing system 102 may also determine if the correlated support issues are valid. Determining if the correlated support issues are valid may comprise performing an automated test suite or test operation to reproduce the performance issue indicated in the correlated support issues. Determining if the correlated support issues are valid may also comprise receiving an indication that the correlated support issues are valid from a user 110 (e.g., an administrator, a quality assurance engineer, a support staff member). The support computing system 102 may also encode an indication in the knowledge base 108 that the correlated support issues are valid or invalid.

Determining if the correlated support issues are valid may comprise determining if an indication of validity or invalidity is encoded in the knowledge base 108. For example, assume a support issue is received and has been determined to be correlated with one or more previously correlated support issues indicated as invalid. As the received support issue has been correlated with invalidated support issues, the received support issue is also invalid. Accordingly, an indication that the received support issue is invalid may also be encoded in the knowledge base 108. Conversely, assume a support issue is received and has been determined to be correlated with one or more previously correlated support issues indicated as valid. As the received support issue has been correlated with validated support issues, the received support issue is also valid. Accordingly, an indication that the received support issue is valid may also be encoded in the knowledge base 108.

The support computing system 102 may identify one or more potentially affected devices 112 associated with the plurality of correlated support issues. A potentially affected device 112 comprises a device that has not yet experienced and/or reported a particular support issue in the correlated support issues but is susceptible to experiencing such a support issues due to a match or similarity in attributes (e.g., a same or similar hardware and/or software configuration). Accordingly, potentially affected devices 112 may comprise a computer, server, mobile device, smart phone, tablet, hand held device, or other computing device as can be appreciated. Identifying the one or more potentially affected devices may comprise identifying one or more devices having attributes matching or similar to the correlated attributes of the correlated support issues. In other words, the potentially affected devices 112 have attributes matching or similar to the attributes shared by the affected devices 104 associated with the correlated support issues.

Identifying one or more potentially affected devices 112 may comprise querying a relational database or lookup table of devices with the correlated attributes to identify the one or more potentially affected devices 112. Identifying one or more potentially affected devices 112 may also comprise applying a machine learning algorithm (e.g., a supervised learning algorithm or unsupervised learning algorithm) to a model indicating the attributes of one or more devices.

Identifying the one or more potentially affected devices 112 may be performed in response to one or more predefined conditions being satisfied. For example, identifying the one or more potentially affected devices 112 may be performed in response to a number of correlated support issues satisfying a threshold. As another example, identifying the one or more potentially affected devices 112 may be performed in response to determining that the correlated support issues are valid. If the one or more predefined conditions are not satisfied, then the one or more potentially affected devices 112 may not be identified and support is not subsequently provided to the potentially affected devices 112.

The support computing system 102 may identify a resolution associated with the correlated support issues. A resolution may comprise one or more actions that, when performed, prevents and/or ends a performance issue associated with the one or more support issues. The actions may comprise actions performed by a user 110 interacting with a device (e.g., a potentially affected device 112). The actions may also comprise a script or batch function executable by a device (e.g., a potentially affected device). A resolution may also comprise a software update, firmware update, operating system update, or other change to executable code that prevents and/or ends a performance issue associated with the one or more support issues. Identifying a resolution associated with the correlated support issues may comprise querying the knowledge base 108. For example, the knowledge base 108 may associate (via a relational database, lookup table, or other data structure) a resolution with one or more of the correlated support issues.

The support computing system 102 may identify the resolution in response to a severity score associated with the correlated support issues satisfying a threshold. The severity score is a quantifiable estimation of the potential of harm associated with the correlated support issues (e.g., a degree to which customers and/or devices may be affected). The severity score may be calculated based on one or more factors including a number of correlated support instances, a frequency of occurrence of the correlated support instances, an associated support tier or flag, a number of potentially affected devices, or other factors.

The support computing system 102 may receive a verification of a resolution. A verification of a resolution comprises a confirmation that a particular resolution prevents and/or ends a performance issue associated with the one or more support issues. Receiving a verification of a resolution may comprise performing the resolution and then performing a test function or test suite that attempts to reproduce the support issue. A failure to reproduce the support issue confirms that the resolution is verified. Receiving the verification of the resolution may comprise receiving the verification from a user 110 (e.g., an administrator, a quality assurance engineer, a customer support representative, etc.). Accordingly, identifying the resolution may comprise identifying a resolution based on receiving the verification (e.g., identifying a resolution that is indicated as verified).

The support computing system 102 may then provide the resolution to one or more entities associated with the potentially affected devices 112. The one or more entities associated with the potentially affected devices 112 may comprise the potentially affected devices 112 themselves. Accordingly, providing the resolution to the one or more entities associated with the potentially affected devices 112 may comprise sending a patch, software update, firmware update, executable script, or other content to the potentially affected devices 112. The one or more entities associated with the potentially affected devices 112 may comprise one or more persons or accounts associated with the potentially affected devices 112 (e.g., a registered user account, a purchaser of a potentially affected device 112, an administrator, etc.). Accordingly, providing the resolution to the one or more entities associated with the potentially affected devices 112 may comprise sending the resolution to a phone number, email address, or other communications identifier of the one or more entities. Where the resolution comprises executable content (e.g., a patch, software update, a firmware update, an executable script), providing the resolution may comprise providing the resolution as an attached or embedded file (e.g., an email attachment), or as a link (e.g., a hyperlink) to the executable content. Where the resolution comprises one or more user-performed actions, providing the resolution may comprise indicating the user-performed actions in a message body, or including a link (e.g., a hyperlink) to a webpage or other resource indicating the user-performed actions.

The support computing system 102 may receive (e.g., from an entity associated with a potentially affected device 112) an indication of a failure of the resolution. The indication of the failure may indicate that the resolution could not be executed (e.g., an error log indicating that a software or firmware update could not be performed). The indication of the failure may also comprise a support issue. Accordingly, receiving the indication of the failure of the resolution may comprise receiving a support issue. In response to receiving the indication of the failure of the resolution, the support computing system 102 may modify the knowledge base 108 based on the indication of failure of the resolution. Modifying the knowledge base 108 may comprise indicating the resolution as invalid.

Where the indication of failure comprises a support issue, modifying the knowledge base 108 may also comprise adding the support issue to the knowledge base 108. Modifying the knowledge base 108 may comprise identifying one or more attributes of a device associated with the added support issue that are distinct from the attributes of the correlated support issues associated with the failed resolution. For example, assume correlated support issues associated with affected devices 104 having a same operating system version, a processor type, and a power supply type (e.g., having correlated attributes of the operating system version, processor type, and power supply type). Assume the indication of failure was received from a device (e.g., a potentially affected device 112 to which the resolution was provided) matching the correlated attributes, hence it being identified as a potentially affected device 112 but having a Random Access Memory (RAM) manufacturer that is distinct from the devices associated with the correlated support issues. The knowledge base 108 may be updated to indicate that the resolution is invalid for hardware configurations including RAM from the particular manufacturer. Accordingly, modifying the knowledge base 108 may comprise creating a rule, flagging the determined attribute, or otherwise modifying the knowledge base 108.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1. cognitive device support for potentially affected devices.

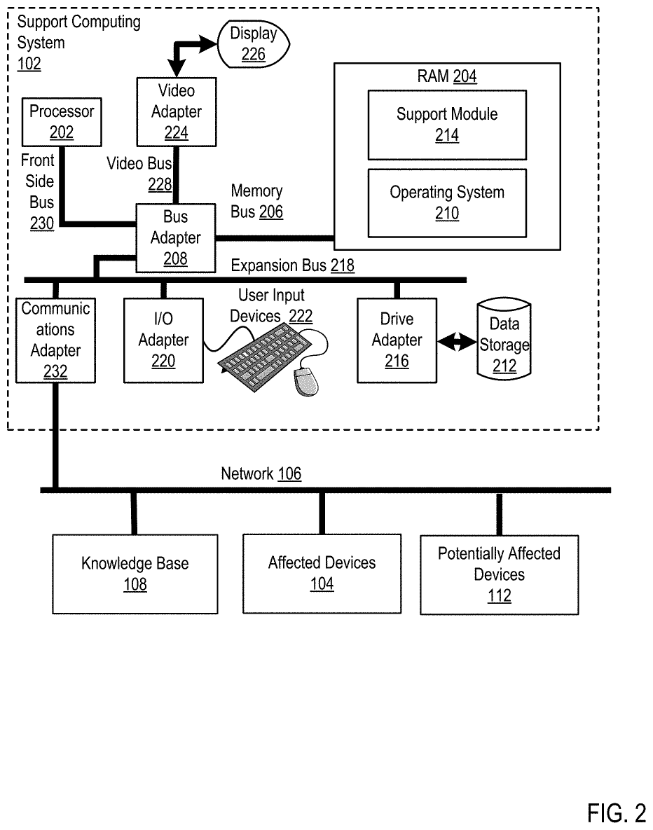

Cognitive device support for potentially affected devices in accordance with the present invention is generally implemented with computers, that is, with automated computing machinery. For further explanation, therefore, FIG. 2 sets forth a block diagram of automated computing machinery comprising an exemplary support computing system 102 configured for cognitive device support for potentially affected devices according to embodiments of the present invention. The support computing system 102 of FIG. 2 includes at least one computer processor 202 or ‘CPU’ as well as random access memory 204 (RAM′) which is connected through a high-speed memory bus 206 and bus adapter 208 to processor 202 and to other components of the support computing system 102.

Stored in RAM 204 is an operating system 210. Operating systems useful in computers configured for cognitive device support for potentially affected devices according to embodiments of the present invention include UNIX™, Linux™, Microsoft Windows™, AIX™, IBM's i OS™, and others as will occur to those of skill in the art. The operating system 210 in the example of FIG. 2 is shown in RAM 204, but many components of such software typically are stored in non-volatile memory also, such as, for example, on data storage 212, such as a disk drive. Also stored in RAM is the support module 214 a module for cognitive device support for potentially affected devices according to embodiments of the present invention.

The support computing system 102 of FIG. 2 includes disk drive adapter 216 coupled through expansion bus 218 and bus adapter 208 to processor 202 and other components of the support computing system 102. Disk drive adapter 216 connects non-volatile data storage to the support computing system 102 in the form of data storage 212. Disk drive adapters useful in computers configured for cognitive device support for potentially affected devices according to embodiments of the present invention include Integrated Drive Electronics (‘IDE’) adapters, Small Computer System Interface (SCSI′) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example support computing system 102 of FIG. 2 includes one or more input/output (‘I/O’) adapters 220. I/O adapters implement user-oriented input/output through, for example, software drivers and computer hardware for controlling output to display devices such as computer display screens, as well as user input from user input devices 222 such as keyboards and mice. The example support computing system 102 of FIG. 2 includes a video adapter 224, which is an example of an I/O adapter specially designed for graphic output to a display device 226 such as a display screen or computer monitor. Video adapter 224 is connected to processor 202 through a high-speed video bus 228, bus adapter 208, and the front side bus 230, which is also a high-speed bus.

The exemplary support computing system 102 of FIG. 2 includes a communications adapter 232 for data communications with other computers and for data communications with a data communications network. Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful in computers configured for cognitive device support for potentially affected devices according to embodiments of the present invention include modems for wired dial-up communications, Ethernet (IEEE 802.3) adapters for wired data communications, and 802.11 adapters for wireless data communications.

The communications adapter 232 is communicatively coupled to a network 106 that also includes one or more affected devices 104, a knowledge base 108, and one or more potentially affected devices 112.

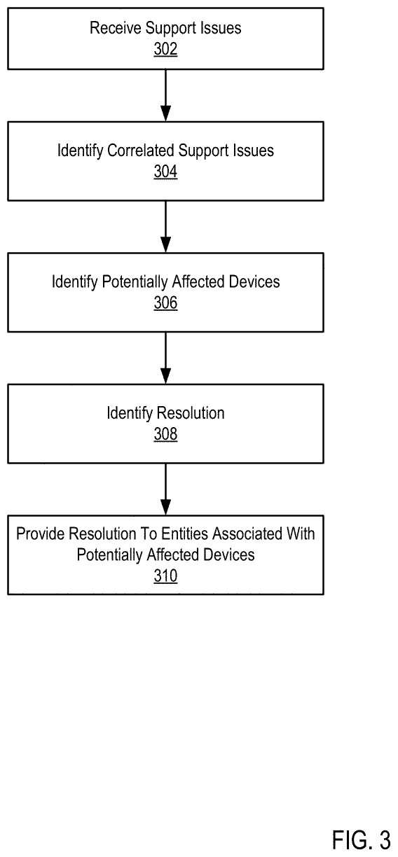

For further explanation, FIG. 3 sets forth a flow chart illustrating an exemplary method for cognitive device support for potentially affected devices according to embodiments of the present invention that includes receiving 302 (e.g., by a support computing system 102) a plurality of support issues. The plurality of support issues may be associated with affected devices 104. The affected devices 104 may comprise a computer, server, mobile device, smart phone, tablet, hand held device, or other computing device as can be appreciated.

The support issues may comprise indications or descriptions of performance issues experienced by a respective affected device 104. For example, such performance issues can comprise software crashes or failures, unexpected or erroneous functionality, hardware failures or outages, or other performance issues as can be appreciated. The support issues may also comprise an identifier of an affected device 104 (e.g., a user identifier, an account identifier, a customer identifier, a device identifier, etc.).

The support issues may also comprise one or more attributes associated with the respective affected device 104. Such attributes can include a description of one or more hardware components of the affected device 104, an indication of an operating system and/or operating system version, an indication of one or more executed applications, or other attributes of the affected device 104.

Receiving the plurality of support issues may comprise receiving an indication of a performance issue from the respective affected device 104. For example, receiving an indication of a performance issue can comprise receiving an error log, stack trace, or other indication of a performance issue. Such an indication of a performance issue may be automatically generated by one or more affected applications, an operating system, or another functional component of the affected device 104. Receiving the plurality of support issues may also comprise receiving an indication of a performance issue as a user input or submission. For example, receiving an indication of a performance issue as a user input or submission may comprise receiving a bug report, support ticket, support email, or other user-generated submission indicating a performance issue.

Receiving the plurality of support issues may also comprise receiving a support issue generated by an analytics engine monitoring social media, chat logs, email messages, text messages, text transcriptions of voice calls or voicemails, or other natural language sources. The analytics engine may analyze natural language data to identify, for example, one or more keywords or descriptors associated with a performance issue. The analytics engine may also determine the affected device based on the natural language data, a user account associated with the natural language data, an identifier included in the natural language data, etc. The analytics engine may then generate the support issue as comprising the keywords, descriptors, an indication of the affected device, etc.

The attributes of the support issue may be received from a source of the support issue (e.g., from the affected device 104, from a user input). One or more attributes of the support issue may also be generated by the support computing system 102 based on another attribute. For example, the support computing system 102 may query a relational database, lookup table, or other data source using a device identifier, user identifier, account identifier, or other identifier to receive one or more other attributes of the affected device 104 (e.g., one or more hardware components of the affected device 104, an operating system of the affected device 104, etc.).

In response to receiving the support issues, the support computing system 102 may store the support issues in a knowledge base 108. The knowledge base 108 encodes known support issues and, if known, resolutions for the support issues. Accordingly, the knowledge base 108 may comprise a relational database, lookup table, machine learning model (e.g., a supervised machine learning model or unsupervised machine learning model), or other data structure.

The method of FIG. 3 may further comprise identifying 304, from the plurality of support issues, one or more correlated support issues having one or more correlated attributes. The one or more correlated support issues are support issues having identical or similar performance issues (e.g., a same error code, having similar keywords or descriptors, having a same predefined category or tag, etc.) and having one or more identical or similar attributes, hereinafter referred to as correlated attributes (e.g., one or more identical or similar hardware components of an affected device 104, a same operating system, a same or similar operating system or software version, etc.). The correlated attributes may be considered to be factors in whether a device may experience a particular support issue. Identifying the one or more correlated support issues may comprise encoded an indication that the one or more support issues are correlated in the knowledge base 108 (e.g., a flag, a reference, a table entry or data structure relating one or more of the support issues).

Identifying one or more correlated support issues may comprise applying a clustering algorithm (e.g., k-means clustering) to the attributes of the support issues in order to generate one or more clusters of support issues. The support issues within a particular cluster may be identified as correlated support issues. Identifying one or more correlated support issues may comprise determining a degree of similarity (e.g., cosine similarity) between the attributes of the support issues. The correlated support issues may then be identified as those support issues having a degree of similarity satisfying a threshold.

The method of FIG. 3 may further comprise identifying 306 (e.g., by the support computing system 102), based on the one or more correlated attributes, one or more potentially affected devices 112 associated with the plurality of correlated support issues. A potentially affected device 112 comprises a device that has not yet experienced and/or reported a particular support issue in the correlated support issues but is susceptible to experiencing such a support issues due to a match or similarity in attributes (e.g., a same or similar hardware and/or software configuration). Accordingly, potentially affected devices 112 may comprise a computer, server, mobile device, smart phone, tablet, hand held device, or other computing device as can be appreciated. Identifying the one or more potentially affected devices may comprise identifying one or more devices having attributes matching or similar to the correlated attributes of the correlated support issues. In other words, the potentially affected devices 112 have attributes matching or similar to the attributes shared by the affected devices 104 associated with the correlated support issues.

Identifying one or more potentially affected devices 112 may comprise querying a relational database or lookup table of devices with the correlated attributes to identify the one or more potentially affected devices 112. Identifying one or more potentially affected devices 112 may also comprise applying a machine learning algorithm (e.g., a supervised learning algorithm or unsupervised learning algorithm) to a model indicating the attributes of one or more devices.

The method of FIG. 3 may further comprise identifying 308 (e.g., by the support computing system 102) a resolution associated with the plurality of correlated support issues. A resolution may comprise one or more actions that, when performed, prevents and/or ends a performance issue associated with the one or more support issues. The actions may comprise actions performed by a user 110 interacting with a device (e.g., a potentially affected device 112). The actions may also comprise a script or batch function executable by a device (e.g., a potentially affected device). A resolution may also comprise a software update, firmware update, operating system update, or other change to executable code that prevents and/or ends a performance issue associated with the one or more support issues. Identifying a resolution associated with the correlated support issues may comprise querying the knowledge base 108. For example, the knowledge base 108 may associate (via a relational database, lookup table, or other data structure) a resolution with one or more of the correlated support issues.

The method of FIG. 3 may further comprise providing 310 (e.g., by the support computing system 112) the resolution to one or more entities associated with the potentially affected devices 112. The one or more entities associated with the potentially affected devices 112 may comprise the potentially affected devices 112 themselves. Accordingly, providing the resolution to the one or more entities associated with the potentially affected devices 112 may comprise sending a patch, software update, firmware update, executable script, or other content to the potentially affected devices 112. The one or more entities associated with the potentially affected devices 112 may comprise one or more persons or accounts associated with the potentially affected devices 112 (e.g., a registered user account, a purchaser of a potentially affected device 112, an administrator, etc.). Accordingly, providing the resolution to the one or more entities associated with the potentially affected devices 112 may comprise sending the resolution to a phone number, email address, or other communications identifier of the one or more entities. Where the resolution comprises executable content (e.g., a patch, software update, a firmware update, an executable script), providing the resolution may comprise providing the resolution as an attached or embedded file (e.g., an email attachment), or as a link (e.g., a hyperlink) to the executable content. Where the resolution comprises one or more user-performed actions, providing the resolution may comprise indicating the user-performed actions in a message body, or including a link (e.g., a hyperlink) to a webpage or other resource indicating the user-performed actions.

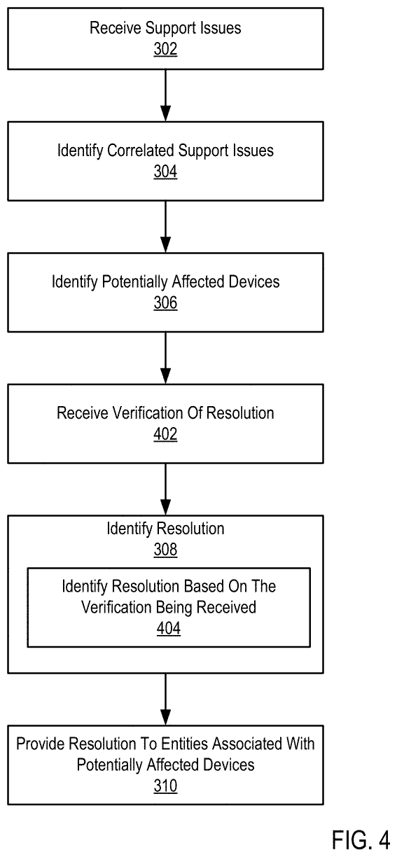

For further explanation, FIG. 4 sets forth a flow chart illustrating a further exemplary method for cognitive device support for potentially affected devices according to embodiments of the present invention that includes receiving 302 a plurality of support issues; identifying 304, from the plurality of support issues, a plurality of correlated support issues having one or more correlated attributes; identifying 306, based on the one or more correlated attributes, one or more potentially affected devices associated with the plurality of correlated support issues; identifying 308 a resolution associated with the plurality of correlated support issues; and providing 310 the resolution to one or more entities associated with the one or more potentially affected devices.

FIG. 4 differs from FIG. 3 in that the method includes receiving 402 a verification of a resolution. A verification of a resolution comprises a confirmation that a particular resolution prevents and/or ends a performance issue associated with the one or more correlated support issues. Receiving a verification of a resolution may comprise performing the resolution and then performing a test function or test suite that attempts to reproduce the support issue. A failure to reproduce the support issue confirms that the resolution is verified. Receiving the verification of the resolution may comprise receiving the verification from a user 110 (e.g., an administrator, a quality assurance engineer, a customer support representative, etc.). The method of FIG. 4 further differs from FIG. 3 in that identifying 308 the resolution comprises identifying 404 the resolution based on the verification being received.

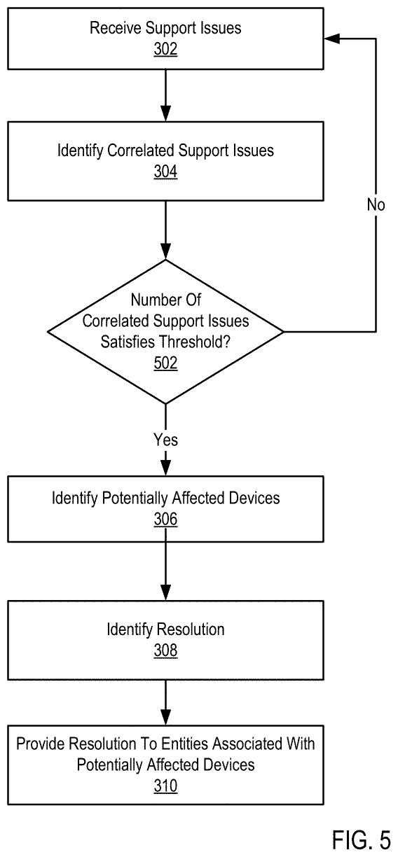

For further explanation, FIG. 5 sets forth a flow chart illustrating a further exemplary method for cognitive device support for potentially affected devices according to embodiments of the present invention that includes receiving 302 a plurality of support issues; identifying 304, from the plurality of support issues, a plurality of correlated support issues having one or more correlated attributes; identifying 306, based on the one or more correlated attributes, one or more potentially affected devices associated with the plurality of correlated support issues; identifying 308 a resolution associated with the plurality of correlated support issues; and providing 310 the resolution to one or more entities associated with the one or more potentially affected devices.

FIG. 5 differs from FIG. 3 in that the method includes determining 502 if a number of correlated support issues (e.g., a number of support issues within a particular grouping of correlated support issues) satisfies a threshold. Determining if a number of correlated support issues satisfies a threshold may comprise determining if a number of correlated support issues within a time window satisfies the threshold. The time window may be based on a time at which a support issue is received. The time window may also be a sliding time window. For example, assuming a threshold of five correlated support issues and a sliding time window of two hours, if a number of correlated support issues satisfies a threshold may comprise determining if at least five of the correlated support issues occurred within a consecutive two-hour period. The time window may also be based on a current time. For example, assuming a threshold of five correlated support issues and a time window of two hours, if a number of correlated support issues satisfies a threshold may comprise determining if at least five of the correlated support issues occurred within the last two hours. If the number of correlated support issues satisfies the threshold, the method of FIG. 5 may proceed to identifying 306 a number of potentially affected devices 112. Otherwise, the method may return to receiving 302 support issues.

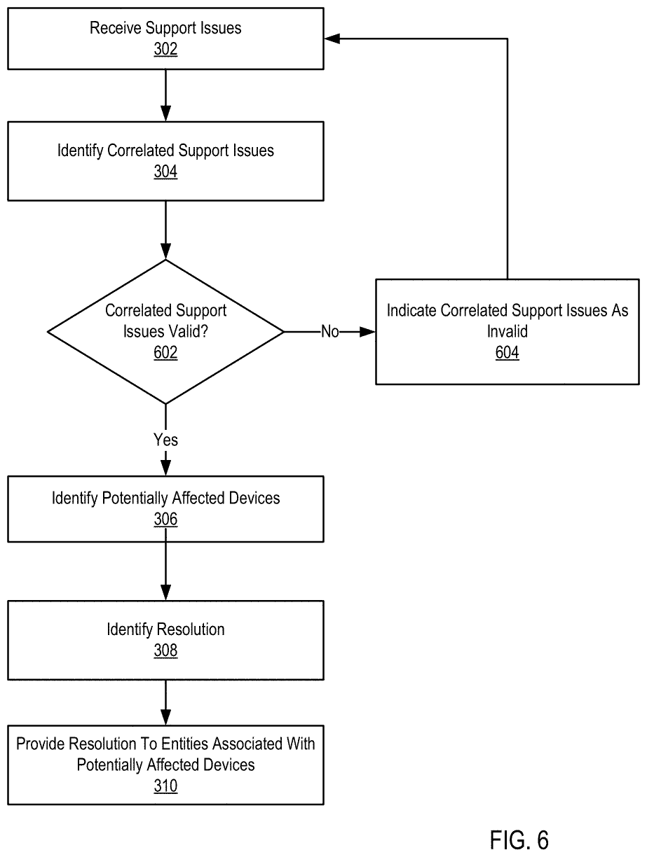

For further explanation, FIG. 6 sets forth a flow chart illustrating a further exemplary method for cognitive device support for potentially affected devices according to embodiments of the present invention that includes receiving 302 a plurality of support issues; identifying 304, from the plurality of support issues, a plurality of correlated support issues having one or more correlated attributes; identifying 306, based on the one or more correlated attributes, one or more potentially affected devices associated with the plurality of correlated support issues; identifying 308 a resolution associated with the plurality of correlated support issues; and providing 310 the resolution to one or more entities associated with the one or more potentially affected devices.

FIG. 6 differs from FIG. 3 in that the method includes determining 602 if the correlated support issues are valid. Determining if the correlated support issues are valid may comprise performing an automated test suite or test operation to reproduce the performance issue indicated in the correlated support issues. Determining if the correlated support issues are valid may also comprise receiving an indication that the correlated support issues are valid from a user 110 (e.g., an administrator, a quality assurance engineer, a support staff member).

Determining if the correlated support issues are valid may comprise determining if an indication of validity or invalidity is encoded in the knowledge base 108. For example, assume a support issue is received and has been determined to be correlated with one or more previously correlated support issues indicated as invalid. As the received support issue has been correlated with invalidated support issues, the received support issue is also invalid. Accordingly, an indication that the received support issue is invalid may also be encoded in the knowledge base 108. Conversely, assume a support issue is received and has been determined to be correlated with one or more previously correlated support issues indicated as valid. As the received support issue has been correlated with validated support issues, the received support issue is also valid.

If the correlated support issues area not valid, the method of FIG. 6 may include indicating 604 that the correlated support issues are invalid. Indicating that the correlated support issues are invalid may include encoding an indication in the knowledge base 108 that the correlated support issues are invalid. If the correlated support issues are valid, the method of FIG. 6 may proceed to identifying 306 the potentially affected devices 112.

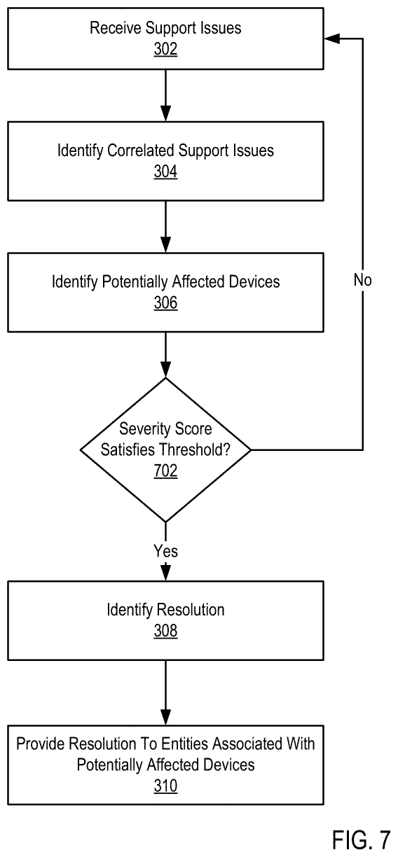

For further explanation, FIG. 7 sets forth a flow chart illustrating a further exemplary method for cognitive device support for potentially affected devices according to embodiments of the present invention that includes receiving 302 a plurality of support issues; identifying 304, from the plurality of support issues, a plurality of correlated support issues having one or more correlated attributes; identifying 306, based on the one or more correlated attributes, one or more potentially affected devices associated with the plurality of correlated support issues; identifying 308 a resolution associated with the plurality of correlated support issues; and providing 310 the resolution to one or more entities associated with the one or more potentially affected devices.

FIG. 7 differs from FIG. 3 in that the method includes determining 702 if a severity score associated with the correlated support issues satisfies a threshold. The severity score is a quantifiable estimation of the potential of harm associated with the correlated support issues (e.g., a degree to which customers and/or devices may be affected). The severity score may be calculated based on one or more factors including a number of correlated support instances, a frequency of occurrence of the correlated support instances, an associated support tier or flag, a number of potentially affected devices, or other factors.

If the severity score fails to satisfy the threshold, the method of FIG. 7 may return to receiving 302 support issues. If the severity score satisfies the threshold, the method of FIG. 7 may proceed to identifying 308 a resolution.

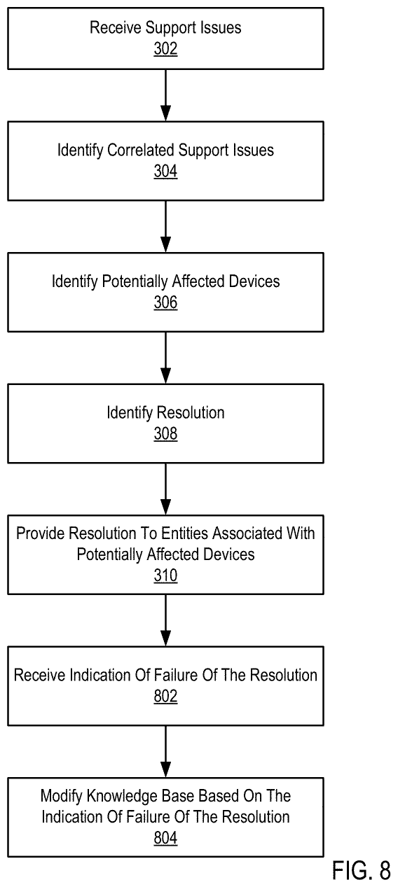

For further explanation, FIG. 8 sets forth a flow chart illustrating a further exemplary method for cognitive device support for potentially affected devices according to embodiments of the present invention that includes receiving 302 a plurality of support issues; identifying 304, from the plurality of support issues, a plurality of correlated support issues having one or more correlated attributes; identifying 306, based on the one or more correlated attributes, one or more potentially affected devices associated with the plurality of correlated support issues; identifying 308 a resolution associated with the plurality of correlated support issues; and providing 310 the resolution to one or more entities associated with the one or more potentially affected devices.

FIG. 8 differs from FIG. 3 in that the method includes receiving 802 (e.g., by a support computing system 102) an indication of failure of the resolution (e.g., from an entity associated with a potentially affected device 112). The indication of the failure may indicate that the resolution could not be executed (e.g., an error log indicating that a software or firmware update could not be performed). The indication of the failure may also comprise a support issue. Accordingly, receiving the indication of the failure of the resolution may comprise receiving a support issue.

FIG. 8 further differs from FIG. 3 in that the method of FIG. 8 comprises modifying 804 the knowledge base 108 based on the indication of failure of the resolution. Modifying the knowledge base 108 may comprise indicating the resolution as invalid. Where the indication of failure comprises a support issue, modifying the knowledge base 108 may also comprise adding the support issue to the knowledge base 108. Modifying the knowledge base 108 may comprise identifying one or more attributes of a device associated with the added support issue that are distinct from the attributes of the correlated support issues associated with the failed resolution. For example, assume correlated support issues associated with affected devices 104 having a same operating system version, a processor type, and a power supply type (e.g., having correlated attributes of the operating system version, processor type, and power supply type). Assume the indication of failure was received from a device (e.g., a potentially affected device 112 to which the resolution was provided) matching the correlated attributes, hence it being identified as a potentially affected device 112 but having a Random Access Memory (RAM) manufacturer that is distinct from the devices associated with the correlated support issues. The knowledge base 108 may be updated to indicate that the resolution is invalid for hardware configurations including RAM from the particular manufacturer. Accordingly, modifying the knowledge base 108 may comprise creating a rule, flagging the determined attribute, or otherwise modifying the knowledge base 108.

In view of the explanations set forth above, readers will recognize that the benefits of cognitive device support for potentially affected devices according to embodiments of the present invention include:
Proactive support for potentially affected devices allows for issues to be prevented before they occur. Thus, devices and users experience fewer performance issues.
Resolutions are provided to specifically identified devices that may be affected by a support issues. Thus, there is reduced overhead, network usage, and computational resource usage when compared to providing resolutions entities associated with a broader set of devices (e.g., all devices).

Exemplary embodiments of the present invention are described largely in the context of a fully functional computer system for cognitive device support for potentially affected devices. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of cognitive device support for potentially affected devices, the method comprising:
receiving a plurality of support issues;
identifying, from the plurality of support issues, a plurality of correlated support issues having one or more correlated attributes;
identifying, based on the one or more correlated attributes, one or more potentially affected devices associated with the plurality of correlated support issues;
identifying a resolution associated with the plurality of correlated support issues; and
providing the resolution to one or more entities associated with the one or more potentially affected devices.

2. The method of claim 1 further comprising:
receiving a verification of the resolution; and
wherein identifying the resolution comprises identifying, based on the verification being received, the resolution.

3. The method of claim 1, further comprising:
determining that a number of the plurality of correlated support issues satisfies a threshold; and
wherein identifying the one or more potentially affected devices comprises identifying, based on the number of the plurality of correlated support issues satisfying the threshold, the one or more potentially affected devices.

4. The method of claim 1, wherein identifying the one or more correlated support issues is based on a knowledge base, and the method further comprises:
determining whether the plurality of correlated support issues are valid;
indicating, in response to the plurality of correlated support issues being invalid, in the knowledge base, the plurality of support issues as invalid; and
wherein identifying the one or more potentially affected devices is performed in response to the plurality of correlated support issues being valid.

5. The method of claim 1, wherein identifying the one or more correlated support issues is based on a knowledge base, and the method further comprises:
receiving an indication of a failure of the resolution; and
modifying, based on the indication of the failure of the resolution, the knowledge base.

6. The method of claim 1, further comprising determining a whether a severity score associated with the plurality of correlated support instances satisfies a threshold.

7. The method of claim 1, wherein identifying the one or more potentially affected devices comprises identifying the one or more potentially affected devices as having the one or more correlated attributes.

8. An apparatus for cognitive device support for potentially affected devices, the apparatus comprising a computer processor, a computer memory operatively coupled to the computer processor, the computer memory having disposed within it computer program instructions that, when executed by the computer processor, cause the apparatus to carry out the steps of:
receiving a plurality of support issues;
identifying, from the plurality of support issues, a plurality of correlated support issues having one or more correlated attributes;
identifying, based on the one or more correlated attributes, one or more potentially affected devices associated with the plurality of correlated support issues;
identifying a resolution associated with the plurality of correlated support issues; and
providing the resolution to one or more entities associated with the one or more potentially affected devices.

9. The apparatus of claim 8, wherein the steps further comprise:
receiving a verification of the resolution; and
wherein identifying the resolution comprises identifying, based on the verification being received, the resolution.

10. The apparatus of claim 8, wherein the steps further comprise:
determining that a number of the plurality of correlated support issues satisfies a threshold; and
wherein identifying the one or more potentially affected devices comprises identifying, based on the number of the plurality of correlated support issues satisfying the threshold, the one or more potentially affected devices.

11. The apparatus of claim 8, wherein identifying the one or more correlated support issues is based on a knowledge base, and the steps further comprise:
determining whether the plurality of correlated support issues are valid;
indicating, in response to the plurality of correlated support issues being invalid, in the knowledge base, the plurality of support issues as invalid; and
wherein identifying the one or more potentially affected devices is performed in response to the plurality of correlated support issues being valid.

12. The apparatus of claim 8, wherein identifying the one or more correlated support issues is based on a knowledge base, and the steps further comprise:
receiving an indication of a failure of the resolution; and
modifying, based on the indication of the failure of the resolution, the knowledge base.

13. The apparatus of claim 8, wherein the steps further comprise determining a whether a severity score associated with the plurality of correlated support instances satisfies a threshold.

14. The apparatus of claim 8, wherein identifying the one or more potentially affected devices comprises identifying the one or more potentially affected devices as having the one or more correlated attributes.

15. A computer program product for cognitive device support for potentially affected devices, the computer program product disposed upon a computer readable medium, the computer program product comprising computer program instructions that, when executed, cause a computer to carry out the steps of:
receiving a plurality of support issues;
identifying, from the plurality of support issues, a plurality of correlated support issues having one or more correlated attributes;
identifying, based on the one or more correlated attributes, one or more potentially affected devices associated with the plurality of correlated support issues;
identifying a resolution associated with the plurality of correlated support issues; and
providing the resolution to one or more entities associated with the one or more potentially affected devices.

16. The computer program product of claim 15, wherein the steps further comprise:
receiving a verification of the resolution; and
wherein identifying the resolution comprises identifying, based on the verification being received, the resolution.

17. The computer program product of claim 15, wherein the steps further comprise:
determining that a number of the plurality of correlated support issues satisfies a threshold; and
wherein identifying the one or more potentially affected devices comprises identifying, based on the number of the plurality of correlated support issues satisfying the threshold, the one or more potentially affected devices.

18. The computer program product of claim 15, wherein identifying the one or more correlated support issues is based on a knowledge base, and the steps further comprise:
determining whether the plurality of correlated support issues are valid;
indicating, in response to the plurality of correlated support issues being invalid, in the knowledge base, the plurality of support issues as invalid; and
wherein identifying the one or more potentially affected devices is performed in response to the plurality of correlated support issues being valid.

19. The computer program product of claim 15, wherein identifying the one or more correlated support issues is based on a knowledge base, and the steps further comprise:
receiving an indication of a failure of the resolution; and
modifying, based on the indication of the failure of the resolution, the knowledge base.

20. The computer program product of claim 15, wherein the steps further comprise determining a whether a severity score associated with the plurality of correlated support instances satisfies a threshold.
